(19) United States
(12) Patent Application Publication
(10) Pub. No.: US 2006/0063051 A1
(43) Pub. Date: Mar. 23, 2006

(54) Metal-air battery with ion-conducting inorganic glass electrolyte

(76) Inventor: Bor Z. Jang, Fargo, ND (US)

Correspondence Address: Bor Z. Jang, 2902 28th Ave. S.W., Fargo, ND, 58103, US

(21) Appl. No.: 10/944,667

(22) Filed: Sep. 20, 2004

(51) Int. Cl. H01M 12/06

(52) U.S. Cl. 429/29

(57) ABSTRACT

A solid-state metal-air electrochemical cell comprising: (A) a metal-containing electro-active anode; (B) an oxygen electro-active cathode; and (C) an ion-conducting glass electrolyte disposed between the metal-containing anode and the oxygen electro-active cathode. The cathode active material, which is oxygen gas, is not stored in the battery but rather fed from the environment. The oxygen cathode is preferably a composite carbon electrode which serves as the cathode current collector on which oxygen molecules are reduced during discharge of the battery to generate electric current. The glass electrolyte typically has an ion conductivity in the range of 5×10⁻⁵ to 2×10⁻³ S/cm. The electrolyte layer is preferably smaller than 10 μm in thickness and further preferably smaller than 1 μm. The anode metal is preferably lithium or lithium alloy, but may be selected from other elements such as sodium, magnesium, calcium, aluminum and zinc.

### FIELD OF THE INVENTION

The present invention relates to a metal-air or metal-oxygen battery with a high energy density. In particular, this invention relates to a battery that contains a non-aqueous, ion-conducting inorganic glass electrolyte.

### BACKGROUND OF THE INVENTION

Metal-air batteries produce electricity by the electrochemical coupling of a reactive metallic anode to an air (oxygen) cathode through a suitable electrolyte in a cell. The air cathode is typically a sheet-like member, having one surface exposed to the atmosphere and another surface exposed to the electrolyte of the cell. A unique feature of a metal-air battery is that the cathode active material (oxygen) is not stored in the battery. Instead, during cell operation, oxygen is supplied naturally from the environment. Oxygen is reduced within the cathode while anode metal is oxidized, providing a usable electric current that flows through an external circuit connected between the anode and the cathode. The cathode must be permeable to air or oxygen but substantially impermeable to aqueous electrolyte, and must incorporate an electrically conductive element to which the external circuit can be connected. Commercial air cathodes typically contain active carbon, a finely divided hydrophobic polymeric material, a dissociation-promoting catalyst, and a metal screen as the conductive element. A variety of anode metals have been used or proposed for use in metal-air cells. However, zinc, lithium, aluminum, magnesium and alloys of these elements are usually considered to be advantageous due to their low cost, light weight, and ability to work with a variety of electrolytes.

For instance, a typical aluminum-air cell comprises a body of aqueous electrolyte, a sheet-like air cathode having one surface exposed to the electrolyte and the other surface exposed to air, and an aluminum alloy anode member (e.g. a flat plate) immersed in the electrolyte. There are two basic types of aqueous electrolytes for metal-air batteries: a neutral-pH electrolyte and a highly alkaline electrolyte. The neutral-pH electrolyte usually contains halide salts and, because of its relatively low electrical conductivity and the virtual insolubility of aluminum therein, is used for relatively low power applications. The highly alkaline electrolyte usually consists of NaOH or KOH solution, and yields a higher cell voltage than the neutral electrolyte. In neutral-pH electrolyte, the cell discharge reaction may be written as:
4Al+3O₂+6H₂O→4Al(OH)₃ (solid) (1)
In alkaline electrolyte, the cell discharge reaction may be written as:
4Al+3O₂+6H₂O+4KOH→4Al(OH)₄⁻+4K⁺(liquid solution), (2)
which is followed, after the dissolved potassium (or sodium) aluminate exceeds a saturation level, by:
4Al(OH)₄⁻+4K⁺″4Al(OH)₃ (solid)+4KOH (3)
In addition to the above oxygen-reducing reactions, there is also an undesirable, non-beneficial reaction of aluminum in both types of electrolyte to form hydrogen, as follows:
2Al+6H₂O→2Al(OH)₃+3H₂ (gas). (4)

The state-of-the-art metal-air batteries have been found to exhibit several shortcomings, the most significant of which is the severe anode corrosion problem caused by water. Several metals have been studied extensively for use in metal-air battery systems, including zinc (Zn), aluminum (Al), magnesium (Mg), and lithium (Li). Calcium (Ca) and sodium (Na) have been studied to a lesser extent. Despite the fact that metals such as Al, Mg, Ca, Na and Li have a much higher energy density than zinc, these five metal anodes (Al, Mg, Ca, Na and Li) suffer from severe corrosion problems. In some cases, the presence of water in an aqueous electrolyte could create a safety concern due to potential violent reactions between Na and water or between Li and water. Hence, Mg-air and Al-air cells are generally operated either as “reserve” batteries in which the electrolyte solution is added to the cell only when it is decided to begin the discharge, or as “mechanically rechargeable” batteries which have replacement anode units available. The presence of oxygen tends to aggravate the corrosion problem. Since the serious corrosion problem of Zn can be more readily inhibited, Zn-air batteries have been thus far the only commercially viable metal-air systems. It is a great pity that metals with high power or energy density like Al, Mg, Ca, Na and Li have not been extensively used in a primary or secondary cell.

There is a need for a battery which can be used as an emergency power source at locations where electric supply lines do not exist. Such a battery must have a high energy capacity and a high power density and be capable of running for a long period of time under high load. There is also a need for a battery that can provide a much extended “talk time” and “stand-by” time for a mobile phone. A need also exists for a battery that can power a notebook computer for a much longer period of time (e.g., 12 hours being needed to last for a trans-Pacific flight). Due to their high energy-to-weight ratio and other advantages, metal-air batteries have been proposed as a preferred energy source for use in electrically-powered vehicles. However, the afore-mentioned problems have severely limited the wider implementation of metal-air batteries.

One particularly interesting and effective attempt to overcome the water corrosion problem was to use a water-free polymeric or organic electrolyte instead of an aqueous electrolyte (J. Read, “Characterization of the Lithium/Oxygen Organic Electrolyte Battery,” Journal of the Electrochemical Society, 149(9) A1190-95, 2002). Abraham and Jiang (“Solid Polymer Electrolyte-Based Oxygen Batteries,” U.S. Pat. No. 5,510,209, Apr. 23, 1996) reported an approach that made use of a polymer electrolyte in a Li/Oxygen battery. The battery was shown to have an open circuit voltage (OCV) close to 3 V, an operating voltage of 2.0 to 2.8 V, and a good coulombic efficiency upon recharge over several cycles. However, the organic or polymer electrolyte-based metal-air cell still suffers from some drawbacks. For instance, a solvent such as ethylene carbonate or propylene carbonate is a required electrolyte ingredient. This is an undesirable feature since solvents could potentially pose a health threat and are often difficult to handle properly in a real manufacturing environment. This type of electrolyte, composed of a polymer host, an electrolyte salt and a solvent, cannot be easily prepared in an ultra-thin film form. Further, a thin liquid solvent-based electrolyte layer is subject to solvent vaporization, resulting in a reduced ion conductivity. The ability to deposit an ultra-thin film is essential to the miniaturization of a battery and related micro-electronic devices. It would be advantageous to have a truly all solid-state electrolyte in a metal-oxygen cell system.

Alamgir and Abraham have disclosed in U.S. Pat. No. 5,252,413 (Oct. 12, 1993), solid polymer electrolyte-based Li batteries in which the cathode active material is TiS₂, V₆O₃, FeS₂, LiNiO₂, LiCoO₂ or LiMn₂O₄ and the polymer electrolyte is composed of poly(vinyl chloride), an aprotic organic solvent and a Li salt (e.g., LiClO₄, LiBF₄, LiAsF₆, LiCF₃SO₃, LiPF₆, or LiN(SO₂CF₃)₂). In these and other Li batteries, the reaction at the solid-state cathode during battery discharge involves the insertion of Li ions into crystal lattice sites in the cathode material with the positive charge on the Li being compensated for by electrons injected into the conduction bands of the cathode material from the external circuit. During recharge of the battery the opposite process takes place. Other Li batteries that require an active cathode material such as an oxide or sulfide are exemplified by Duchange, et al. (U.S. Pat. No. 4,444,857, Apr. 24, 1984) and Iwamoto, et al. (U.S. Pat. No. 5,677,081, Oct. 14, 1997), which both make use of a solid-state electrolyte.

In this patent application, ion-conducting inorganic glass electrolyte-based metal-oxygen batteries (including extremely high-capacity Li-oxygen and Na-oxygen batteries) are disclosed. These novel batteries are unlike any of the polymer, organic, or other solid-state electrolyte-based batteries known to-date. The presently invented batteries have oxygen (O₂) gas as their electro-active cathode material, which is not stored inside the battery. Instead, the oxygen gas is fed from the surrounding air. Further, the battery discharge reaction involves the reduction of oxygen to form lithium oxide (when Li is the primary anode active material) or sodium oxide (when anode involves Na as an active material).

### SUMMARY OF THE INVENTION

It is an object of the present invention to provide a metal-oxygen (metal-air) electrochemical cell or battery that features a safe and reliable solid-state electrolyte.

It is another object of the present invention to provide a battery that exhibits little or no anode corrosion problem.

Still another object of the present invention is to provide a metal-air battery that has a high energy density or a long operating life.

The presently invented solid-state metal-air electrochemical cell comprises: (A) a metal-containing electro-active anode; (B) an oxygen electro-active cathode; and (C) an ion-conducting glass electrolyte disposed between the metal-containing anode and the oxygen electro-active cathode. The cathode active material, which is oxygen gas, is not stored in the battery but rather fed from the environment. The oxygen cathode is preferably a composite carbon electrode which serves as the cathode current collector on which oxygen molecules are reduced during discharge of the battery to generate electric current. The glass electrolyte typically has an ion conductivity in the range of 5×10⁻⁵ to 2×10⁻³ S/cm. The electrolyte layer is preferably smaller than 10 μm in thickness and further preferably smaller than 1 μm. The anode metal is preferably lithium or lithium alloy, but may be selected from other elements such as sodium, magnesium, calcium, aluminum and zinc.

For a lithium-based anode, for instance, a particularly useful group of solid electrolyte is a lithium sulfide-, lithium oxide-, or mixed lithium sulfide/lithium oxide-based glass material represented by Li₂S—X, Li₂O—X, or Li₂S—X—Y, wherein X represents at least one member selected from the group consisting of SiS₂, Al₂S₃, P₂S₅, and B₂S₃, and Y represents at least one member selected from the group consisting of Li₂O, Li₃PO₄, Li₂SO₄, and Li₂CO₃ for its electrolyte layer.

### BRIEF DESCRIPTION OF THE DRAWINGS

FIG. 1 A solid electrolyte metal-air cell featuring an ion-conducting glass electrolyte.

FIG. 2 The discharge behavior of a Li/O₂ cell with a silicon oxide (SiOₓ)—(LiOₓ)-based glass electrolyte film.

FIG. 3 The discharge behavior for Li/O₂ solid-state batteries with an acetylene black carbon composite electrode current collector and a (Li₂O)—X(AₙDₘ)-based electrolyte.

### DESCRIPTION OF THE PREFERRED EMBODIMENTS

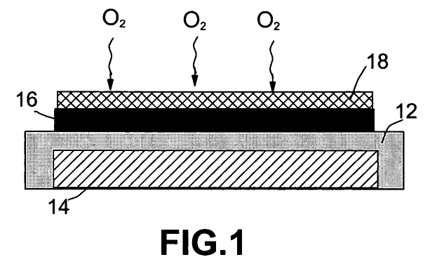

The invention is best illustrated by referring to FIG. 1 which depicts a solid-state electrolyte-based Li/O₂ battery cell. In FIG. 1, 12 is the solid-state (ion-conducting glass) electrolyte, 14 is the Li or Na anode (negative electrode), 16 is the composite positive electrode (a current collector) prepared from graphite powder or carbon black, O₂ is oxygen, the electro-active cathode material, which is supplied from the environment, and 18 is an oxygen permeable membrane through which O₂ is transported to the porous carbon electrode.

Several groups of ion-conducting glass materials may be used as an electrolyte in the presently invented solid-state metal-oxygen batteries. For a lithium-based anode, for instance, the solid electrolyte may be a glass material represented by Li₂S—X or Li₂S—X—Y, wherein X represents at least one member selected from the group consisting of SiS₂, Al₂S₃, P₂S₅, and B₂S₃, and Y represents at least one member selected from the group consisting of Li₂O, Li₃PO₄, Li₂SO₄, and Li₂CO₃ for its electrolyte layer. When the composition of the solid electrolyte is represented by the formula aLi₂S—(1−a)X or bY—(1−b)[aLi₂S—(1−a)X], it is preferable that 0.3<a<1 and 0<b<0.3. These glass solid electrolytes do not contain any halide and, hence, they do not form any high impedance layer or region on the surface of the anode due to the reaction of the metal active material with the halide. The solid electrolyte in a thick disk or slab form may be prepared in the following manner: After mixing the predetermined amounts of the raw materials, the mixture are filled in a glassy carbon crucible and allowed to react in a flowing argon gas at 1,000° C. for 2 hours. The obtained molten reaction product is quenched rapidly by means of a twin roller to suppress any potential crystallization, giving rise to an amorphous, glassy state. Their thin-film counterparts may be prepared by vacuum evaporation or sputtering.

The glass electrolyte is preferably made to be in close contact with the surface of the anode, so that the anode active material is effectively prevented from falling off from the electrode even if the active material is reduced into minute particles by possibly alloying with other metal elements. A good contact also allows for increased surface area which can participate in the reaction. As a result, current distribution on the electrode is relatively uniform, and no lithium dendrites are formed. The potential problem of short-circuiting inside the battery due to the dendrite formation can effectively be prevented. This dendrite formation problem has presented the most serious reliability issue in a conventional rechargeable Li battery and is now effectively eliminated in the presently invented lithium-oxygen secondary battery.

A good contact between a metal anode and a solid electrolyte can be achieved by direct deposition of a thin film of the solid electrolyte onto the metal anode, which itself can be a thin or thick film. Thin film deposition can be achieved through techniques such simple vacuum evaporation, sputtering, laser ablation, physical vapor deposition (PVD), chemical vapor deposition (CVD), and plasma-assisted PVD or CVD. The ion conductivity of the electrolyte should be fairly high and the electrolyte layer should be made relatively thin. This is briefly explained as follows: Many non-aqueous rechargeable battery chemistries operate at current densities below 5 mA/cm². In order to ensure a high battery operating voltage during discharge, resistive losses across the electrolyte film must be minimized. The resistive loss across a conductive film can be calculated according to Ohm's Law V=IR. To ensure that voltage drop across the thin film is less than 100 mV at 5 mA/cm², the resistance of the film should be less than 20 Ωcm². For a 1,000 angstrom (Å) thick film the maximum resistivity of the film is then calculated as R=ρl/A, p=RA/l=20 (1)/0.00001 cm=2×10⁶ Ωcm. Therefore the conductivity of the film is preferably greater than 5×10⁻⁷ siemens/cm (S/cm or Ω⁻¹ cm⁻¹). For a 10 μm thick film, the ion conductivity must be greater than 5×10⁻⁵ siemens/cm. If a lower voltage drop is desired (e.g., <10 mV), then the ion conductivity of the electrolyte layer must be greater than 5×10⁻⁴ siemens/cm at room temperature. This would not be possible for many ion-conductive glass compositions unless they are made into an ultra-thin film.

In order to provide the needed ionic conductivity, the electrolyte layer preferably contains a mobile ion such as an alkali metal cation of the negative electrode metal (Li, Na, etc.). Many suitable single ion conductors are known; e.g., those that may be characterized as containing a “modifier” portion and a “network former” portion of a glass material. The modifier is often an oxide of the alkali metal (i.e., the metal ion to which the electrolyte is conductive). The network former is often a polymeric oxide or sulfide. One example is the lithium silicate glass 2Li₂O-1SiO₂ and another example is the sodium borosilicate glass 2Na₂O-1SiO₂-2B₂O₃.

When alkali metal anodes are used, preferred modifier/network former glasses for use in practicing this invention may have the general formula (M₂O)—X(AₙDₘ), where M is an alkali metal, A is boron, aluminum, silicon, or phosphorous, and D is oxygen or sulfur. The values of n and m are dependent upon the valence on A and X is a coefficient that varies depending upon the desired properties of the glass. Generally, the conductivity of the glass increases as the value of X decreases. However, if the value of X becomes too small, the modifier and network former tend to undergo phase separation. Generally, the glass should remain of a single phase, so the value of X must be carefully chosen.

The highest concentration of M₂O should be that which yields the stoichiometry of the fully ionic salt of the network former. For instance, SiO₂ is a polymeric covalent material. As Li₂O is added to silica, O—O bonds are broken, yielding Si—O Li⁺. The limit of Li₂O addition is at the completely ionic stoichiometry, which for silica would be Li₄SiO₄ or Li₂—SiO₂ (Li₂O-0.5SiO₂). Any addition of Li₂O beyond this stoichiometry would necessarily lead to phase separation of Li₂O and Li₄SiO₄. The ionic limit can be regarded as an upper maximum beyond which phase separation will occur regardless of thermal history. The same limitation can be calculated for all network formers, i.e. Li₃BO₃ or 3 Li₂O—B₂O₃, Li₃AlO₃ or 3 Li₂O—Al₂O₃, etc. The optimum values of X will vary depending upon the modifier and network former employed.

Useful examples of the modifier include lithium oxide (Li₂O), lithium sulfide (Li₂S), lithium selenide (Li₂Se), sodium oxide (Na₂O), sodium sulfide (Na₂S), sodium selenide (Na₂Se), potassium oxide (K₂O), potassium sulfide (K₂S), potassium selenide (K₂Se) and their combinations. Examples of the network former include silicon dioxide (SiO₂), silicon sulfide (SiS₂), silicon selenide (SiSe₂), boron oxide (B₂O₃), boron sulfide (B₂S₃), boron selenide (B₂Se₃), aluminum oxide (Al₂O₃), aluminum sulfide (Al₂S₃), aluminum selenide (Al₂Se₃), phosphorous pentoxide (P₂O₂), phosphorous pentasulfide (P₂S₅), phosphorous pentaselenide (P₂Se₅), phosphorous tetraoxide (PO₄), phosphorous tetrasulfide (PS₄), phosphorous tetraselenide (PSe₂), and related network formers.

In addition, dopants may be added to the above two-part ion-conductive glasses to further modify the physical and chemical properties. The dopant may be a simple halide of the ion to which the glass is conductive; e.g., lithium iodide (LiI), lithium chloride (LiCl), lithium bromide (LiBr), sodium iodide (NaI), sodium chloride (NaCl), and sodium bromide (NaBr). Such doped glasses may have general formula (M₂O)—X(AₙDₘ)—Y(MH) where Y is a coefficient and MH is a metal halide. The addition of metal halides to glasses is quite different than the addition of metal oxides or network modifiers to glasses. In the case of network modifier addition, the covalent nature of the glass is reduced with increasing modifier proportion and the glass becomes more ionic in nature. The addition of metal halides may be understood better in terms of the addition of a salt solute (MH) to a solid solvent (the modifier/former glass) to form a solid solution. The solubility of a metal halide (MH) in a glass will also depend on the thermal history of the glass. In general, the ionic conductivity of a glass increases with increasing dopant (MH) concentration until the point of phase separation.

The above-cited electrolytes comprise, among others, a lithium silicate, a lithium borate, a lithium aluminate, a lithium phosphate, a lithium phosphorus oxynitride, a lithium silicosulfide, a lithium borosulfide, a lithium aluminosulfide, and a lithium phosphosulfide. Some other single ion conductor glasses may also be employed as an electrolyte layer used with this invention. One example is a lithium phosphorus oxynitride glass referred to as LiPON which is described in “A Stable Thin-Film Lithium Electrolyte: Lithium Phosphorus Oxynitride,” J. Electrochem. Soc., 144, 524 (1997). An example composition for LiPON is Li_{2.9} PO_{3.3}N_{0.5}. Examples of other glass films that may work include 6LiI—Li₃PO₄—P₂S₅ and B₂O₃—LiCO₃—Li₃PO₄.

For sodium metal active anode battery applications, the sodium ion conducting glasses may be prepared from certain sodium aluminum phosphate, sodium aluminum borate, or sodium borophosphate containing up to 11 mole percent of ZrO₂, MaO or SiO₂; e.g., a glass consisting of 50 mole percent Na₂O, 38 mole percent P₂O₅, 12 mole percent Al₂O₃, 2 mole percent MgO and 4 mole percent SiO₂. The preparation of these glasses using conventional glass-forming processes are disclosed by Booth in U.S. Pat. No.4,181,579 (Jan. 1, 1980); U.S. Pat. No. 4,190,500 (Feb. 26, 1980); and U.S. Pat. No.4,206,016 (Jun. 3, 1980). These series of glasses have a sodium ion conductivity being in the range of 2−7×10⁻⁴ Ω⁻¹cm⁻¹ at 300° C. Their sodium ion conductivity at room temperature drops to below 1×10⁻⁶ Ω⁻¹cm⁻¹ and, hence, these glasses would not be very useful for solid electrolyte metal-air batteries that operate at room temperature unless the electrolyte layer is made to be ultra-thin.

In the presently invented high energy density ambient temperature battery, the negative electrode (anode) material preferably consists of lithium or sodium. For certain other battery applications it may consist of lithium alloy or amalgam. If a lithium alloy is used, it preferably is a lithium-tin, lithium-lead, lithium-zinc, lithium-aluminum or lithium-magnesium alloy having at least 50%, more preferably at least 65% lithium by weight.

The porous electrode on which O₂ is reduced during discharge of the battery is preferably fabricated as a composite electrode from a mixture consisting of a high surface area carbon powder and a binder such as polytetrafluoroethylene (PTFE) or polyvinylidene (PVDF)-hexa-fluoropropylene. Candidates for the high surface area carbon include graphite powder or a poorly crystalline carbon such as acetylene black. The purpose of the carbon is to provide an electrode surface to reduce O₂ during discharge of the battery. Consequently, any carbon with a sufficiently high surface area can be used. In general, carbons having higher surface areas are preferred since the rate of discharge of the battery increases with increasing surface area of the carbon used for fabricating the positive electrode (cathode). A high surface area carbon also allows the preparation of a positive electrode current collector with sufficiently high porosity to allow permeation of high concentrations of O₂ into the interior of the carbon electrode for efficient reduction. An optional oxygen-reducing catalyst such as Pt, Pd, Ni, and TiO₂ may be used to increase the cathode reaction rate. The Li/O₂ batteries of this invention have an open-circuit voltage of approximately in the range of 2.7-2.85 V, which is consistent with the cell reaction:
2Li+½O₂→Li₂O; E°=2.91 V (5)

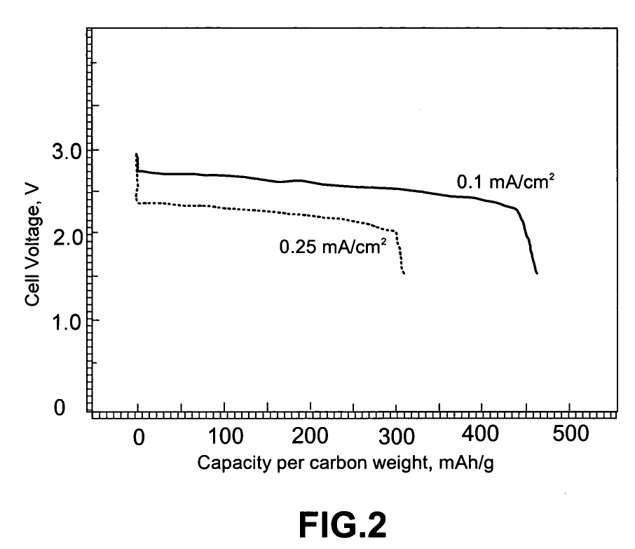

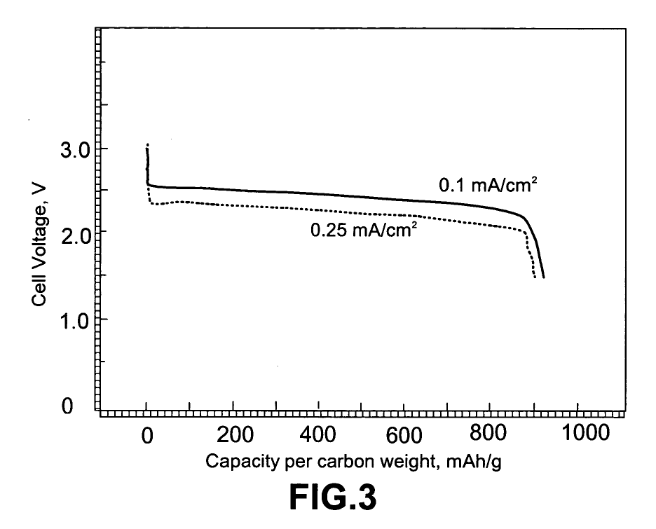

Depending upon the current density, the load voltage of the cell during discharge varies between this open-circuit voltage and about 2.0 V. FIG. 2 shows typical discharge curves for Li/O₂ solid-state batteries with a graphite composite positive electrode current collector and a silicon oxide (SiOₓ)—(LiOₓ)-based glass electrolyte. FIG. 3 depicts the discharge curves for Li/O₂ solid-state batteries with an acetylene black carbon composite electrode current collector and a (Li₂O)—X(AₙDₘ)-based electrolyte. The cell capacity is expressed as the electrochemical charge obtained, in milliampere-hour (mAh) per gram of carbon in the composite positive electrode.

The solid-state electrolyte-based metal-oxygen battery of this invention can be made with an anode other than one containing Li. These metal-containing electro-active anodes may include an alkali metal selected from the group consisting of Na, K, Rb, and Cs, an alkaline earth metal selected from the group consisting of Be, Mg, Ca, Sr, Ba, and a metal selected from the group consisting of Zn, Fe, Al, Mn, Ti, Cr and Ni, and alloys thereof. For instance, Na, Ca, Mg or Zn may be substituted for Li to give polymer electrolyte-based Na/O₂, Ca/O₂, Mg/O₂ and Zn/O₂ batteries, respectively. Ion-conducting glass electrolyte in such batteries is conductive to the ion of the metal with which the anode is made up of. The electrochemical reactions in these cells and their calculated cell voltages are given in the following equations:
2Na+½O₂→Na₂O, E°=1.94 V (6)
Ca+½O₂→CaO, E°=3.12 V (7)
Mg+½O₂→MgO, E°=2.93 V (8)
Zn+½O₂→ZnO, E°=1.65 V (9)
Al+ 3/2O₂→Al₂O₃, E°=2.73 V (10)

The following examples are used to further illustrate the present invention:

### EXAMPLE 1

A plasma-assisted CVD was used to prepare silicon oxide (SiOₓ)—(LiOₓ)-based films on Li-coated glass substrate by introduction of an organosilicon compound into a plasma reactor. Liquid organosilicon, 1,1,3,3-tetra-methyl-disiloxane, was slightly heated to produce a vapor pressure of the siloxane sufficient to sustain a silicon flux to the plasma. A radio frequency-heated Li—Al rod was used to generate a stream of Li vapor into the plasma chamber essentially concurrently with siloxane vapor. A metering valve and a mass flow meter connected in series were used to control the flux of organosilicon. The lithium silicate deposition was continued until the thickness was approximately 2,000 Å.

The carbon air electrode was prepared by mixing a 10 wt. % PTFE emulsion (containing 0.05 to 0.5 μm PTFE particles in water) with carbon black. The mixture was stirred and ultrasonicated for 10 minutes and then dried in a vacuum at 80° C. The dried paste was milled to form a fine powder, which was cold-pressed onto a Ni grid.

The Li/glass electrolyte/carbon cell package was enclosed in a D-cell can and an atmosphere of oxygen gas was maintained inside the can. The cell showed an open circuit voltage (OCV) of 2.69V. Two cell specimens were discharged at room temperature at 0.1 mA/cm² and 0.25 mA/cm², respectively, to a 1.5 V cutoff. The performance of this cell is shown in FIG. 2.

### EXAMPLE 2

A lithium metal thin film having a thickness of 10 μm was formed on a copper foil having a size of 100 mm×50 mm and a thickness of 10 μm by vacuum evaporation and deposition. On the thin film of the lithium metal, a thin film of an inorganic glass electrolyte was formed to have a thickness of 1 μm. The glass electrolyte was selected from the following list (Table 1):

TABLE 1
The ion conductivity, open circuit voltage (OCV), and discharge
voltage (at a current density of 0.1 mA/cm²) of selected
Li/oxygen batteries.

| | | | | Dis- |
|---|---|---|---|---|
| | | Ionic | | charge |
| Sam- | Chemical composition | conductivity | OCV | Voltage |
| ple | of glass electrolyte | S/cm | Volts | Volts |
| 2-a | 60Li₂S—39.5SiS₂—0.5Li₃PO₄ | 1.8 × 10⁻³ | 2.86 | 2.60 |
| 2-b | 57Li₂S—38SiS₂—5(Li₂O—P₂O₅) | 2.0 × 10⁻³ | 2.79 | 2.5 |
| 2-c | 57Li₂S—38SiS₂—5(Li₄SiO₄) | 2.0 × 10⁻³ | 2.85 | 2.56 |
| 2-d | 57Li₂S—38SiS₂—5Li₃BO₃ | 1.8 × 10⁻³ | 2.86 | 2.52 |

The carbon-based oxygen electrode and the resulting Li/glass electrolyte/carbon cell package for Samples 2-a through 2-d were prepared according to the same procedures as in Example 1.

### EXAMPLE 3

Samples 3-a, 3-b, 3-c, and 3-d were similar to Samples 2-a, 2-b, 2-c, and 2-d, respectively; but the glass electrolyte layer was approximately 10 μm instead of 1 μm. The discharge voltages of the Li/O₂ batteries with thicker electrolyte layers appear to be smaller than those of their thinner counterparts (Table 2).

TABLE 2
The ion conductivity, open circuit voltage (OCV), and
discharge voltage (at a current density of 0.1 mA/cm²) of
selected Li/oxygen batteries.

| | | | | Dis- |
|---|---|---|---|---|
| | | Ionic | | charge |
| Sam- | Chemical composition | conductivity | OCV | Voltage |
| ple | of glass electrolyte (10 μm thick) | S/cm | Volts | Volts |
| 2-a | 60Li₂S—39.5SiS₂—0.5Li₃PO₄ | 1.8 × 10⁻³ | 2.85 | 2.51 |
| 2-b | 57Li₂S—38SiS₂—5(Li₂O—P₂O₅) | 2.0 × 10⁻³ | 2.77 | 2.40 |
| 2-c | 57Li₂S—38SiS₂—5(Li₄SiO₄) | 2.0 × 10⁻³ | 2.83 | 2.44 |
| 2-d | 57Li₂S—38SiS₂—5Li₃BO₃ | 1.8 × 10⁻³ | 2.83 | 2.41 |

It may be noted that the performance of the presently invented metal-air batteries is comparable to that of the polymer/solvent-based metal-air batteries disclosed by Abraham and Jiang in U.S. Pat. No. 5,510,209, Apr. 23, 1996). However, the presently invented inorganic glass electrolyte-based batteries do not exhibit drawbacks suffered by the organic or polymer electrolyte-based metal-air cells. For instance, a solvent such as ethylene carbonate or propylene carbonate is a required electrolyte ingredient in the polymer/solvent cell, which is an undesirable feature since solvents could potentially pose a health threat and are often difficult to handle properly in a real manufacturing environment. The mixture of a polymer host, an electrolyte salt and a solvent cannot be easily prepared in an ultra-thin film form. The ability to deposit an ultra-thin film electrolyte is essential to the miniaturization of a battery and related micro-electronic devices. Further, a liquid solvent-based electrolyte layer is subject to solvent vaporization, leading to a reduced ion conductivity. The presently invented cells, being truly all solid-state, are clearly more advantageous in solid state electronics applications.

1. A solid-state metal-air electrochemical cell comprising:
(A) a metal-containing electro-active anode;
(B) an oxygen electro-active cathode; and
(C) an ion-conducting glass electrolyte disposed between said metal-containing anode and said oxygen electro-active cathode.

2. The cell of claim 1 wherein said glass electrolyte is in a thin film form with a thickness no greater than 10 μm.

3. The cell of claim 1 wherein said glass electrolyte is in a thin film form with a thickness no greater than 1 μm.

4. The cell of claim 1, wherein the electrolyte comprises at least one of a lithium silicate, a lithium borate, a lithium aluminate, a lithium phosphate, a lithium phosphorus oxynitride, a lithium silicosulfide, a lithium borosulfide, a lithium aluminosulfide, and a lithium phosphosulfide.

5. The cell of claim 1, wherein the electrolyte comprises a glass material represented by Li₂S—X or Li₂S—X—Y, wherein X represents at least one member selected from the group consisting of SiS₂, Al₂S₃, P₂S₅, and B₂S₃, and Y represents at least one member selected from the group consisting of Li₂O, Li₃PO₄, Li₂SO₄, and Li₂CO₃.

6. The cell of claim 1, wherein the electrolyte comprises a glass material represented by the general formula (M₂O)—X(AₙDₘ)—Y(MH), where M is an alkali metal, A is boron, aluminum, silicon, or phosphorous, D is oxygen or sulfur, Y is a coefficient and MH is a metal halide.

7. The cell of claim 1, wherein the electrolyte has an ion conductivity in the range of 5×10⁻⁵ to 2×10⁻³ S/cm.

8. The cell of claim 1 wherein said metal-containing electro-active anode is Li.

9. The cell of claim 1 wherein said metal-containing electro-active anode is a lithium alloy selected from the group consisting of lithium-aluminum, lithium-tin, lithium-magnesium, lithium-lead, lithium-zinc and lithium-boron.

10. The cell of claim 1 wherein said metal-containing electro-active anode is an alkali metal selected from the group consisting of Na, K, Rb, and Cs.

11. The cell of claim 1 wherein said metal-containing electro-active anode is an alkaline earth metal selected from the group consisting of Be, Mg, Ca, Sr, Ba, and alloys thereof.

12. The cell of claim 1 wherein said metal-containing electro-active anode is a metal selected from the group consisting of Zn, Fe, Al, Mn, Ti, Cr and Ni.

13. The cell of claim 1 wherein said electrolyte is prepared by a deposition technique selected from the group consisting of simple vacuum evaporation, sputtering, laser ablation, physical vapor deposition (PVD), chemical vapor deposition (CVD), plasma-assisted PVD and plasma-assisted CVD.

14. The cell of claim 1 wherein said oxygen cathode comprises a carbon material and a binder that form a porous structure.
